(19) United States
(12) Patent Application Publication
(10) Pub. No.: US 2003/0074106 A1
(43) Pub. Date: Apr. 17, 2003

(54) System and method of extracting data from vending machines

(75) Inventor: Glenn D. Butler, Westwood, MA (US)

Correspondence Address: Hughes & Luce, L.L.P., J. Davis Gilmer, Suite 2800, 1717 Main Street, Dallas, TX, 75201, US

(73) Assignee: Crane Co., Stamford, CT

(21) Appl. No.: 09/943,279

(22) Filed: Feb. 21, 2002

Related U.S. Application Data
(60) Provisional application No. 60/228,975, filed on Aug. 30, 2000.

(51) Int. Cl. G06F 17/00

(52) U.S. Cl. 700/236

(57) ABSTRACT

Aspects of the invention are found in a method for collecting information associated with a vending machine. The method has the steps of detecting a vending event associated with the vending machine; storing a dataset stored in a standard format associated with the vending event; retrieving the dataset; parsing at least one data field from the dataset; transmitting the at least one data field. In one embodiment the standard format is the DEX format. Further the data field may be sent in a data packet. The data packet may be compressed and encrypted before sending. Further, the data packet may be transmitted with an identifier associated with the machine. The data field can be transmitted to a handheld circuitry, which could be wireless in nature. The at least one data field may be transmitted to a central monitoring facility. The data field may be transmitted by wireless communication and/or through an interconnected network. Further the data packet may be transmitted through various communications means including a telephone line, an Ethernet, a wireless Ethernet, a two-way paging system, a mobile phone system, a cellular phone system, a packet-radio system, a fiber optic network and the Bluetooth (TM) wireless communication standard. The data packet may also be parsed and/or sent in response to a polling signal.

This application claims priority to U.S. Provisional Application Serial No. 60/228,975, filed Aug. 30, 2000 entitled “SYSTEM AND METHOD OF EXTRACTING DATA FROM VENDING MACHINES,” and is incorporated herein by reference in its entirety.

### TECHNICAL FIELD OF THE INVENTION

This invention relates generally to a system and method of managing product inventories and deliveries of such products. More specifically, the present invention relates to systems and methods of tracking, managing, and accounting for product inventories and/or operability from data extracted directly from remotely located equipment.

### BACKGROUND OF THE INVENTION

Many problems arise from remotely locating equipment. These problems are exemplified by the vending merchandising industry. Worldwide demand for sophisticated vending merchandising systems is increasing. To be successful, vending operators need to manage their vending resources, just as traditional retailers manage their inventories and product offerings.

The nature of the vending industry is unique. This industry requires that special accounting problems be addressed that do not fit into traditional business models and accounting software packages. The day-to-day operations of a vending company differ from those of both manufacturing and distribution companies which produce and sell a product. Rather, vending companies place products for sale in automatic merchandising systems where these products are later purchased. This requires that a sales tax component be built into price of the product to be vended and that the appropriate funds are received from a delivery person when the vending machine is serviced.

Since the automatic merchandising system is located remotely from the vendor, problems arise. These problems include lost sales from inoperable machines, lost sales when machines are depleted of merchandise, and poor customer satisfaction. Poor customer satisfaction may result from machine errors in vending, returning change, or accepting tender, among others. Further, frequent errors may lead to habitual refusal to patron machines by potential customers.

Attempts have been made to standardize the format of data collected by vending machines. One standard format is the DEX format. “DEX” or DEX/UCS stands for Data Exchange/Uniform Communications Standard. Within the vending industry, this defines the transfer of information or data between a hand held computer or other form of data collector and an electonic vending machine. Back in the mid 1970's the Food Marketing Institute, along with major food retailers, define the original DEX framework. Their objective was to standardize the transfer of product information between a supermarket's computer and the delivery drivers hand held computer. The Uniform Code Council is the organization that maintains and updates this communication protocol.

In 1986, the NAMA Vending Technology Standards Committee in conjunction with the European Vending Association (EVA), Technical Committee created the Data Transfer Standard. This set the base line for information to be collected in a vending machine and how that information would be retrieved. At that time, the DEX Protocol was incorporated as an intricate part of the DTS.

Since the vending industry was considerably late in adopting electronics to operate vending machines, the Data Transfer Standard was not a definitive standard and was not universally applied. Different software engineers from different vending machine manufacturers and software suppliers to the industry were interpreting parts of the standard in different ways. As a result vending operators and software suppliers were experiencing great difficulty in obtaining information from machines because of this lack of standardization. This was complicated by the fact that the European vending industry was not using DEX to retrieve their information as were those in the United States. Thus, until there were enough electronic vending machines in the field and enough vending operators beginning to retrieve data, the NAMA Vending Technology Standards Committee did not realize the problems occurring as a result of the lack of universal acceptance of a standard. The extent of the problem was finally brought to the attention of the committee by Audit Systems Company who specialized in retrofitting old machines with a DEX read box.

At the next meeting of the Standards Committee at the NAMA Spring Expo 2000 several vending operators who were initiating data retrieval from their machines expressed frustration with the problems. Based on the information provided on the extent of problems, the committee set the correction of the DEX problems as their number one priority to be handled immediately after the final adoption of the MDB/ICP Standard in October 2000.

At the Spring Expo 2000, Audit Systems Company to put together a white paper detailing the items they felt that needed correction and/or revision in the DTS relating to DEX. This paper was presented at the Fall Technology Committee Meeting. At the fall Technology Committee meeting, vending operators, software suppliers and representatives from the EVA Technical Committee discussed the DEX problems. It was decided to have a special meeting in 2001 to discuss the DEX problems and determine how to correct the problems.

On Feb. 14, 2001 a meeting was held in Chicago with full participation from all segments of the industry. As a result of this meeting a working group of the Technology Committee was charged with developing specific recommendations to change the specifications set forth in Chapter 4 of the DTS-EVA document dealing with the DEX protocol and other items they felt needed to be revised relating to DEX.

This working group of the Technology Committee put together a proposed revision of Chapter 4 of the Data Transfer Standard and submitted it to the Technology Committee for their concurrence at their meeting held at the NAMA spring Expo in Las Vegas. This revision was agreed upon and sent to the EVA Technical Committee for their review and discussion. At the May 15-16, 2001 meeting of the EVA Technical Committee, extensive discussion was held regarding the proposed revision to the DEX Protocol set forth in Chapter 4. In addition, since only two sections from the DEX/UCS document from Uniform Code Council are suggested for use, specific section references were added so engineers would know which specific items must be incorporated into their code in order for the DEX Protocol to work.

As a result of the May 2001 meeting a second revised document was prepared and reviewed by the NAMA Working Group. If all parties agree then the EVA/DTS Document will be revised incorporating this revised Chapter 4, a new Error Code Table and a host of other minor changes. This will prevent miscellaneous interpretations as had been done in the past.

However, a standardized data format does not address all of the problems of the vending machine industry. Other issues remain such as inventory management, cash accounting, and scheduling inefficiencies.

Prior art methodologies and software packages that have addressed inventory management issues have been character based, user unfriendly, and extremely inflexible to changes in the business process or methodology and software package. Known prior art solutions are built on proprietary databases with proprietary report writers. This eliminates the flexibility to customize and interface with other applications.

Another problem to be overcome is that prior art systems are often based on the premise of tracking price point category level products within a vending machine. This premise was built around a delivery model in which a vending service person refills a snack machine and only records how many snacks or products at a given price were placed into the machine.

Another problem encountered with existing vending business methods is the lack of a practical means to manage different delivery trucks and personnel servicing individual vending machines and still maintain an acceptable level of accountability. Conversely, there has not been an efficient way to manage and track contents in multiple vending machines serviced by a single delivery service. Prior art solutions have been designed around the assumption that vending machines are assigned to fixed delivery routes. This assumption makes it extremely difficult to change delivery schedules associated with individual machines.

A further problem associated with the vending industry is the lack of real time or quasi-real time data. This has required that complicated methods of estimating actual inventory levels be developed to service vending machines.

Further, prior solutions do not offer a means to service or account for multiple inventory zones. Rather, prior solutions rely on fixed inventory zones. Fixed inventory zones associate a single storage facility and delivery service with a single vending machine. These prior solutions are incapable of easily accounting for multiple inventory sites being associated with multiple delivery services and multiple vending machines and still ensuring accountability. These solutions do not facilitate the accounting of products within the aggregated inventory of vending services. Thus, theft was an often-encountered problem.

Furthermore, prior solutions do not track multiple bar codes or SKU's associated with a single product. For example, suppliers often modify the barcodes of individual products that are associated with a promotion. This change can cause problems with traditional methodologies of tracking vended items as the bar codes are used to identify the product. Similarly, prior art systems often are incapable of handling different package types for a single product. For example, a product may be available as a single item, a box or a case wherein there were 36 items in a box and 12 boxes in a case. Delivery services might inventory the product according to the cases in a warehouse, by the box during delivery, and as single items in the vending machine. An additional problem associated with existing accountability systems is that prior art solutions did not have a way to properly calculate commissions in automated merchandising.

The vending machine industry exemplifies many problems found in locating other equipment remotely. These problems include lost operation time caused by unnoted loss in machine functionality and less than optimal profit. Operating losses may include time while the machine is inoperable, poor service scheduling where an unnecessary service visit occurs, poor service scheduling where a required visit does not occur, and a failure to account for inventories, among others.

As such, many typical management systems for remotely located equipment suffer from deficiencies. For the vending machine industry, these deficiencies may be in providing accurate accounting of inventory and collected moneys. Many other problems and disadvantages of the prior art will become apparent to one skilled in the art after comparing such prior art with the present invention as described herein.

### SUMMARY OF THE INVENTION

The present invention provides an accountability software system designed for the vending industry that substantially eliminates or reduces disadvantages and problems associated with previously developed accounting software systems that have been applied or used for the vending industry. More specifically, the present invention provides a sophisticated vending and merchandising system and method that accounts for the tracking, managing and accounting of vended merchandise, funds received, and servicing of related equipment.

The present invention provides a method of extracting data directly from a vending machine in real, quasi-real time, or on a specified schedule. To do this, data and data files onboard the vending machine are locally accessed. These files may be in the DATA TRANSFER STANDARD or DEX format. The present invention should not be limited to this particular format, rather any data standard or protocol known to those skilled in the art may be used. This local data and data file may comprise a great number of unnecessary data fields and data points. In order to optimize the transmission of necessary data, a set of required data fields are identified. Then the set of required data fields are parsed from the local data and data file. The steps of identifying the set of required data fields and parsing or extracting this set from the larger data file can be achieved locally onboard the vending machine. This greatly reduces the required transmission bandwidth and remote processing. Alternatively, the larger data file can be transmitted without this benefit for auditing purposes of the transmitted required fields. However, this does reduce transmission and processing efficiency.

The smaller set of data fields can then be compressed and transmitted from a remote site to a local server. Embodiments may use network, telephone, wireless, fiberoptic or other communication pathways to transmit data fields to a local server. Alternatively, this smaller set of data fields can be compressed and transmitted to a personal data assistant (PDA) or other hand held device.

The reduced set of data fields can be used by client application to develop financial and accounting reports. Also, a set of business logic rules can be used to extract marketing data. Such data can be used to evaluate the performance of an individual machine through profit and loss analysis, as well as the performance of individual products and product lines in real time.

The wireless nature of this data set allows a centralized facility, via a wireless server, to poll individual machines and accurately determine inventory and delivery requirements. Alternatively, individual vending machines can report alarm conditions immediately as they occur. Such conditions may include loss of power, low inventory, door ajar, and other such conditions as known to those skilled in the art.

Other mechanisms for streamlining the transmission of this data include monitoring local data files only reporting differences between a prior data file and the current data file.

The present invention allows vending operators to manage their vending resources just as traditional retailers manage their inventories and product offerings. The present invention provides an integrated information tracking system that allows vending operators to stock machines, control inventory and manage route schedules.

Real time or near real time market data is provided through the data collected and available on individual products and inventories contained within individual vending machines serves as a source of point of sale marketing data for the vending industry. T offers an integrated value added vending and merchandising solution with enhanced and new market channels for a broad range of products and service providers. By analyzing the data better marketing strategies can be developed.

To be successful, vending operators must manage their vending resources just as retailers manage their inventories and product offerings. The present invention through an innovative software solution provides an integrated information tracking system that allows vending operators to stock machines, control inventory and manage route schedules. The present invention provides the vending industry to effectively monitor and control purchase orders associated with an automated merchandising system. Prior art solutions required that a hard copy purchase order be generated and physically delivered in order to have new goods delivered. Additionally, these systems were not interactive or dynamic, merely providing a static order. The present invention allows purchase orders to be dynamically generated based on the actual inventory contained within individual vending machines.

The present invention also provides the vending industry with the ability to perform dynamic route scheduling for a network of vending machines. This allows the servicing of the vending machines to respond to a dynamic environment such as holidays while balancing the loads and inventory of products delivered to the individual machines. Balancing the inventory load and the workload of individual service providers such as route drivers and cash counters can prevent inefficiencies associated with support personnel and facilities. This prevents overloading support functions associated with the vending machine network, such as overloading the money collection facility by having all the funds delivered at one time. This also prevents underutilizing one route driver will overloading another.

The present invention provides an important technical advantage by providing a user-friendly cash reconciliation system and method associated with a vending merchandising system. The present invention allows the user to automatically associate a money bag via a bar code or other unique identifier with a specific vending machine. When coupled with an automatic coin counter or monetary counter, funds present are reconciled with the funds collected from the vending machine and the inventory within an individual vending machine. This avoids the problems associated with prior art solutions where a dollar value is manually associated with an individual money bag, then manually associated with an individual machine, and in turn manually entered into a database.

Additionally, the present invention may incorporate business rules into the product management database. Prior art solutions previously used proprietary report writers to display the results of calculations which over distributed network can be extremely slow. The present invention is not based on a proprietary report writer built specifically for one database. Rather, the present invention is based on a standardized database with a user friendly graphical user interface. This allows the logic placed into the business rules to stay resident within the product management database. The advantage of making the logic of the business rules resident on the database is that a multi-branch vending company with diverse geographic locations can maintain the logic resident within a main server for the entire company. Thus, all processing occurs at the server only the results are displayed to an individual service provider in the field when requested.

The standardized approach of the present invention provides yet another technical advantage as other software engines such as Microsoft Excel and Word can directly link with the present invention to create individualized reports via a single keystroke.

Yet another important technical advantage provided by the present invention is the ability to synchronize data contained locally at individual vending machines with a network via a network connection such as those provided by the internet or TCP/IP protocol or other similar protocol as known to those skilled in the art.

A handheld computing device can be linked to the vending machines via a network connection, wireless connection, infra-red connection or internet connection using appropriate protocols to allow real time information to be associated with the tracking inventory, inventory management and route scheduling functions provided by the present invention.

The present invention provides an important benefit by allowing vending operators to manage their vending resources just as traditional retailers have managed their inventories and product offerings. The present invention provides an integrated information tracking system that allows vending operators to stock machine, control inventory, and manage route schedules.

Another technical advantage provided by the present invention is the ability to collect point of sale data associated with the vending industry. This allows vending operators to be more successful by using traditional tools to manage their vending resources just as retailers have managed their inventories and product offerings. Traditionally, vending operators have not been able to collect direct real time point of sale data. The present invention as executed by an innovative software solution provides the vending operator an integrated information tracking system allowing the vending operators to dynamically stock machines, control inventory and manage route schedules.

The present invention provides yet another important technical advantage over prior art solutions for the vending industry in the ability to address sales taxes at any level within a hierarchy of a vending business. The software solution of the present invention allows individual products and machines to be tracked and the proper sales taxes to be computed for those machines rather than manually assigning sales tax values or commissions to individual products associated with machines. By dynamically linking and networking vending machines, a vending operator can through the point of sale data collected generate dynamic purchase orders in order to fill or stock a vending machine according to a just in time schedule. This allows delivery services to optimize the inventory they carry and to fill or restock machines as needed in a dynamic manner. This dynamic function additionally allows vending operators to balance their loads of both inventory products and manpower in a cost effective manner.

The present invention provides yet another important technical advantage by allowing a user to interface with a graphical user interface and define customized fields and automatically enter cash and inventory reconciliation data via a network connection to the individual vending machines and coin and automatic money counters.

Although the present invention has been described in detail herein with reference to the illustrative embodiments, it should be understood that the description is by way of example only and is not to be construed in a limiting sense. It is to be further understood, therefore, that numerous changes in the details of the embodiments of this invention and additional embodiments of this invention will be apparent to, and may be made by, persons of ordinary skill in the art having reference to this description. It is contemplated that all such changes and additional embodiments are within the spirit and true scope of this invention as claimed below.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 is a schematic block diagram depicting an interconnected network to which at least one vending machine is coupled among other devices, according to the invention.

FIG. 2 is a schematic block diagram depicting an interconnected network to which multiple vending machines are connected according to the invention of FIG. 1.

FIG. 3. is a schematic block diagram depicting one exemplary embodiment according to the invention depicted in FIG. 1.

FIG. 4 is another schematic block diagram depicting an exemplary embodiment according to the invention depicted in FIG. 1.

FIG. 5 is a schematic block diagram depicting another exemplary embodiment according to the invention depicted in FIG. 1.

FIG. 6 is a schematic block diagram depicting a vending machine for use in the invention of FIG. 1.

FIG. 7 is a block flow diagram depicting an exemplary method for processing data associated with a vending event for transfer across the interconnected network of FIG. 1.

FIG. 8 is a schematic block diagram of a system for inventory management according to the invention depicted in FIG. 1.

FIG. 9 is a schematic block diagram of a system for supply chain management according to the invention depicted in FIG. 1.

FIG. 10 is a schematic block diagram of a business logic server for use in the system according to the invention depicted in FIG. 1.

FIG. 11 is a schematic block diagram of a handheld circuitry for use in the invention depicted in FIG. 1.

### DETAILED DESCRIPTION OF THE PREFERRED EMBODIMENT

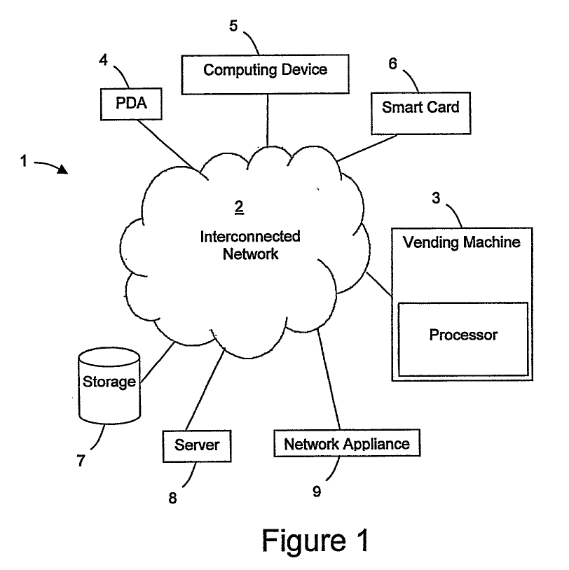

Exemplary embodiments of the present invention are illustrated in FIGS. 1 through 11 of the drawings, like numerals being used for like and corresponding parts of the various drawings.

FIG. 1 is a schematic block diagram depicting an interconnected network to which at least one vending machine is coupled among other devices, according to the invention. The system 1 comprises several devices connected to an interconnected network 2. Remotely located equipment such as a vending machine 3 may be connected to the interconnected network 2. This vending machine 3 may communicate with other devices that are also connected to the interconnected network 2.

For example, these device may include a handheld circuitry such as a portable digital assistant (PDA) 4, a computing device 5, a smart card 6, a network storage device 7, a server 8, a network appliance 9 and others. The vending machine 3 may communicate with these devices through the interconnected network 2.

The vending machine 3 may, for example, communicate information associated with vending events. These vending events may be associated with the sale of a specific item, events relating to the operation of the machine, or errors associated with the operation of the machine, among others. Data collected in association with the one or more vending event may be produced and/or stored in many different forms. These forms may include the DTS and DEX file format standard, among others.

The communicated information may be a reduced set of the dataset collected in association with one or more vending events. This reduced set of information may be transmitted across the interconnected network 2. However, the complete data set may also be transmitted across the interconnected network 2.

The reduced set of information may be acquired by parsing the dataset associated with the one or more vending events. For example, a customer may purchase a drink item from a drink dispensing machine. This drink item may be associated with a column in a vending machine. The vending machine may collect information associated with the column, the amount paid, the tender received, the denominations of change given, and a time associated with the purchase, among others. Parts of this information may be extracted, such as the identity of the column and the purchase time. This part of the dataset or these data fields may be transferred across the interconnected network 2, to a PDA 4 or a server 8. Further, the PDA 4 or server 8 may transfer the data fields to other devices.

In addition, the data fields may be transferred as a packet of information. This packet may also include an identifier uniquely associated with the vending machine 3. The packet may be compressed and/or encrypted in advance of transferring.

The interconnected network 2 may take many forms. These forms may include a local area network (LAN) and a wide area network (WAN). These forms may also include wireless communication means and hardwired means. These means may be combined in any configuration. The communication means may include a telephone line, an Ethernet connection, a wireless Ethernet connection, a two-way paging system, a mobile phone system, infrared communications, satellite communication, radio communication, and RS-232 hardwired communication, among others. The communications means may utilize several protocols and standards including the Reflex (TM) two-way paging standards, the Bluetooth (TM) wireless communications standard, Ethernet 802.11, cellular phone standards such as (CDPD, AMPS, GSM, CDMA), packet radio standards (mobitex (TM), DataTec(TM)), TCP/IP protocols and others.

Further, the data fields or the packet of information may be transferred across the interconnected network 2 using many protocols associated with the communication means. These protocols may include standard protocols such as TCP/IP, Bluetooth (TM) protocols, CDMA, and Ethernet 802.11, among others.

By transmitting packets of information across the interconnected network 2, a remote service can monitor vending machines and remotely located equipment. This monitoring may enable the vending service to monitor spending and machine operability. Further, information associated with vending locations can be transmitted to suppliers, service personnel, warehouses, and others. Efficiencies in product delivery, cash accounting, maintenance scheduling and other actions associated with remotely located equipment may be derived from the monitoring of the machine and communication with other devices.

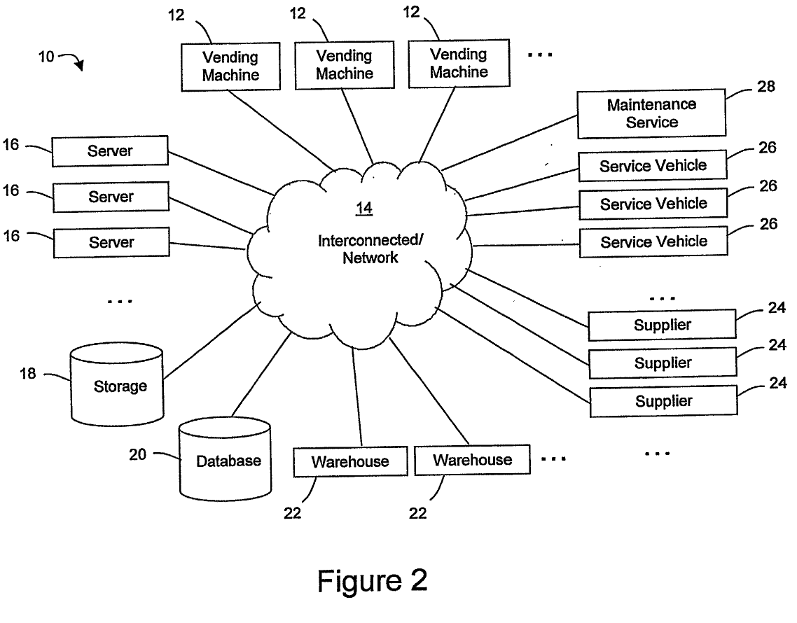

FIG. 2 is a schematic block diagram depicting an interconnected network to which multiple vending machines are connected according to the invention of FIG. 1. Through the interconnected network 14, multiple remotely located equipments such as vending machines 12 may be interconnected with other devices and services. These devices may be a plurality of server 16, network storage devices 18, databases 20, warehouses 22, maintenance services 28, service vehicles 26, and suppliers 24.

For example, the system 10 may operate such that the vending machines 12 transmit data packets as described above. These packets may be transmitted to a handheld device (not shown) or to a server 16. These packets may also be transferred to the server 16 by way of a handheld device. The servers 16 may manipulate the data packets, store the data packets, add information from the data packets to a database 20 or perform other functions. Furthermore, the servers 16 may provide information to end users associated with suppliers 24, warehouses 22, service vehicles 26, maintenance services 28 through means such as the world wide web (WWW) in the form of a website and/or through data standards such as hyper text markup language (HTML) and/or XML.

The information from the data packets may be used to predict and/or schedule maintenance service 28 and inventory service, and route service vehicles 26. The information from the data packets may aid in accounting for cash and inventories. In addition, the data from the data packets may be used to predict and/or build purchase orders for communication with suppliers 24 and warehouses 22. The data from the data packets may also be used to improve and/or optimize product selection and placement.

In another exemplary embodiment, the remotely located equipment such as a vending machine 12 may transfer information such as the data packet to a handheld device. The handheld device may transfer the data packet to a server 16 through the interconnected network 14.

In a further exemplary embodiment, the remotely located equipment may transfer the data packet through the interconnected network 14 in response to a polling signal. The polling signal may be initiated by a handheld device, a cell phone, or a server, among others.

The data packets may take many forms and be derived in many ways. These ways and forms may include those described in associate with FIG. 1, among others.

The interconnected network 14 may also take many forms. These forms may include those described above in association with FIG. 1, among others. Similarly, the data packets may by transferred using many standard protocols. These protocols may include those described in association with FIG. 1, among others. Further, the interconnected network 14 may be any combination of communications means.

Through this system 10, remotely located equipment such as vending machines 12 may be managed. This management may include improved route and maintenance scheduling, optimized routing, more accurate cash accounting, more accurate inventory accounting, improved inventory management, and improved product selection, among others.

Further, the system 10 of FIG. 2 may have one server 16. The one server 16 may act as a business logic database server. The one server 16 may be connected to multiple vending machines 12, and multiple locations such as warehouses 22 and services (24, 26, 28). The server 16 may provided filtered access to individual locations. For example, the server 16 may permit a warehouse 22 to access transaction information associated with vending machines 12 assigned to the warehouse 22. However, the server 16 may prevent access to vending machine transaction histories by other warehouses.

In another example, the server 16 may provide filtered access to sales information associated with products supplied by a specific supplier 24. However, the server 16 may block access to information associated with products not supplied by that supplier 24.

The server 16 may also act as a gateway to interaction with the vending machines 12. The server or servers 16 may collect information from the vending machines 12. Further, the server or servers 16 may manipulate adjustable functionality or programs associated with the vending machines 12.

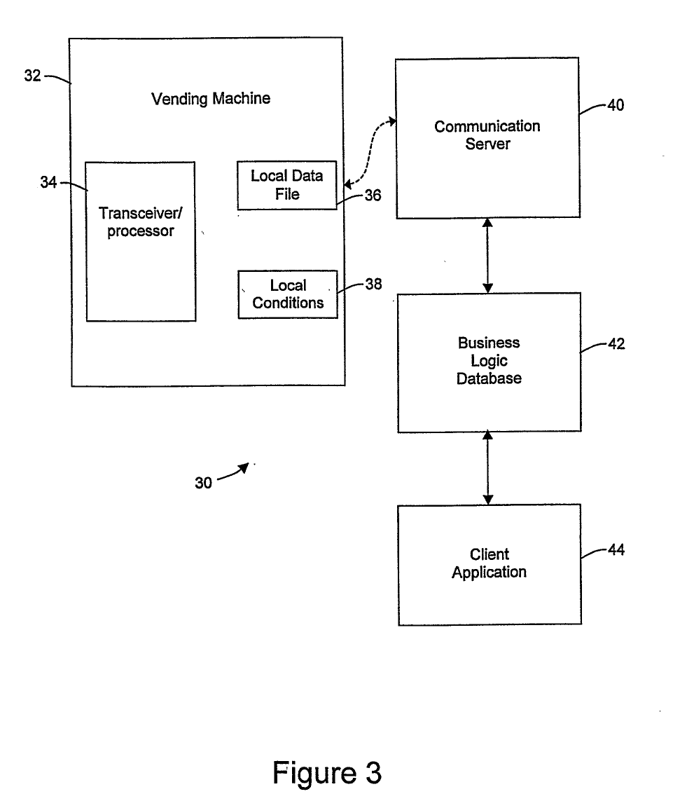

FIG. 3. is a schematic block diagram depicting one exemplary embodiment according to the invention depicted in FIG. 1. The system 30 has a vending machine 32 connected to a network. The vending machine 32 may communicate information associated with the operability of the vending machine and vending transactions through the network.

In one exemplary embodiment, the vending machine has a circuitry which may act as a processor and/or transceiver 34. The circuitry 34 may be coupled to a local data file 36 and/or an indicator of a local condition 38.

The local data file 36 may contain information associated with vending events such as transaction events and operation events. The local data file 36 may, for example be a database of a transaction history. In another example, the local data file 36 may be a data stream stored in a standard format. This standard format may, for example, be the DEX format, among others. The DEX data file is generally a large ASCII file.

The local conditions 38 may take many forms. These forms may be associated with the operability of the machine and may include indicators associated with electrical power, errors, operability, inventory levels, internal temperature, motion sensors, times related to last vending event, and others. These forms may also relate to external conditions such as external temperature, local activity sensors, vandalism indicators, and others.

The circuitry 34 may act to parse information from the local data file 36 and/or the local conditions 38. For example, the system user may desire only specific elements or data fields of a DEX data file. The circuitry 34 may parse these elements or data fields from the DEX data file. This information may then be transmitted through a network. The parsed information may take the form of a efficient data packet and may also include an identifier associated with the machine 32. This identifier may be an identification unique to the machine or it may be an indication of model, location, and/or manufacturer, among others.

In addition, the data packet may be compressed and/or encrypted before transfer. Many compression routines and encryption methods are available, both standard and proprietary.

The network may take many forms. In an exemplary embodiment, a wireless communications means connects a vending machine 32 to a communications server 40. The communications server is coupled to a business logic database 42. The business logic database 42 is coupled to a client application 44.

The wireless communications means may take many forms. These forms may include a two-way pager system, a cellular telephone system, a packet-radio system and others. The wireless communications means may also utilize wireless communications standards including the Bluetooth (TM) wireless communications standard, the wireless Ethernet 802.11 communications standard, Reflex (TM) two-way paging standards, cellular phone standards such as (CDPD, AMPS, GSM, CDMA), packet radio standards (mobitex (TM), DataTec(TM)), TCP/IP protocols and others.

The communications server 40 may take many forms. These forms may include a server associated with two-way pager system, a cellular telephone system, or a packet radio system, among others. The communications server 40 may also be a system hardwired to an interconnected network through a phone line or an Ethernet, among others. The vending machine may transfer the information through a wireless means to a local communications server which then transfers the information to the business logic database 42 through the hardwired interconnected network. Further, the communications server may take the form of a handheld circuitry, such as a personal digital assistant (PDA). The vending machine 32 may transfer the information to the PDA communication server 40 through a local wireless communication means such as circuitry conforming to the Bluetooth (TM) or Ethernet 802.11 wireless communications standards, among others. The vending machine 32 may alternatively transfer the information to the PDA 40 through a RS-232 communications link. The PDA may then be connected to the business logic database through a distant wireless means such as, for example, a cellular phone network or a two-way pager network, among others. Alternatively, the PDA may connect to the business logic database directly, through a hardwired network, or through an infrared communications means, among others.

The business logic database may take many forms. These forms may include any database, standard accounting system, or information management system, among others. For example, the business logic database may be a Microsoft SQL Server database residing on a compatible computer. The business logic database may also take the forms of, a Microsoft Jet database, an Oracle database, and an SAP database, among others residing on compatible computers. In addition, the business logic database may have other features associated with standard tools. These standard tools may include online analytical processing (OLAP) tools. These tools may be derived from vendors such as Microsoft and Cognos. Further, the business logic database may be accessible through several standard means such as SQL queries, XML, and HTML. The database may also conform to interface standard such as Microsoft's Active X standard.

The client application may take many forms. These forms may include a stand-alone application or a web-based application. For example, the stand-alone application may be a Microsoft Windows based program. The stand-alone application may be written in a programming language such as Visual Basic, C/C++, Java, and others. The web-based application may be a program accessible through a browser such as Netscape's Navigator or Microsoft's Internet Explorer web browsers. The web-based application may take the form of client side scripts such as javascripts and visual basic scripts. The web-based applications may also take the form of server side scripts such as server side java scripts, perl, active server pages, and others.

The communications server may be coupled to the business logic server through several means. These means may include a wireless means such as a two-way pager system, a cellular telephone system, a packet-radio system, a satellite communications system, an infrared A communications system, and others. The wireless means may also include circuitry conforming to the Bluetooth (TM) communications standard, the Ethernet 802.11 standard and others. Further, the communications server may coupled to the business logic server through hardwired means such as a telephone network, an Ethernet connection, and others. Further, the communications server may connect to the business logic database through the wireless means, the hardwired means, or any combination of the various forms of the various means.

The business logic server may be coupled to the client application through several means. These means may include any of the means for connecting the communications server to the business logic database or any combination thereof.

The system 30 may operate, for example, such that the vending machine 32 parses information from the local data file 36 and/or the local conditions 38 using the circuitry 34. For example, the information may be a transaction time associated with a column in a drink vending machine. In another example, the information may be the temperature of an ice machine and an associated time. The information may take many forms.

The information may then be transmitted using the circuitry 34 to the communication server 40 through a wireless means. The circuitry 34 may parse and transmit the information in response to a polling signal from the communications server. The communications server 40 may then transfer the information to a business logic database 42. This transfer may occur through a communications means as described in relation to the system of FIG. 1. For example, the transfer may occur through an interconnected network using the TCP/IP protocols.

The business logic database 42 may store and use the information in many ways. The information may be used as part of an inventory accounting function, a cash accounting function, a service route optimization function, a product selection function, or any other function relating to remotely located equipment.

The business logic database 42 may then be accessed by a client application 44. The client application 44 may access the business logic database 42 through a communications means as described in relation to the system of FIG. 1. For example, the client application 44 may access the business logic database 42 through an interconnected network using the TCP/IP protocols.

The client application 44 may function to display information in the business logic database 42. The client application 44 may also function in an inventory accounting function, a cash accounting function, a service route optimization function, a product selection function, or any other function relating to remotely located equipment. The client application 42 may also have report generating functions. These report generating functions may be standardized using software such as Seagate's Crystal Reports Report Writer, among others. These reports may be supplied by the operator of the business logic database or customize for specific client applications. These reports may use information and query results from the business logic database.

Further, the client application and/or the business logic database may utilize online analytical processing (OLAP). OLAP and other tools can be utilized to provide predictive functionality and data mining. The client application and/or the business logic database may represent information in data cubes and through other means to make data analysis easier.

Each of the parts described may be coupled as shown or in any configuration. Many configurations are possible which delivery beneficial functionalities.

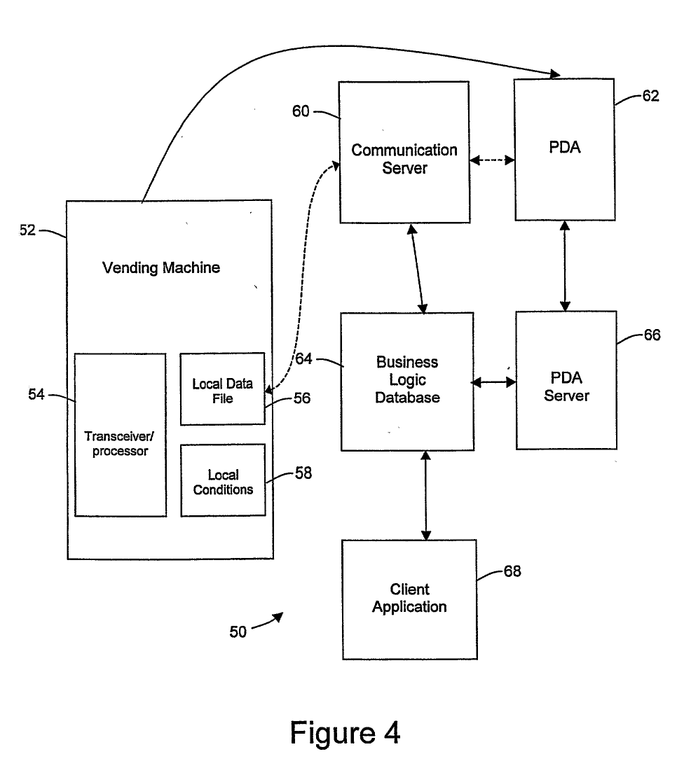

FIG. 4 is another schematic block diagram depicting an exemplary embodiment according to the invention depicted in FIG. 1. The system 50 has a remotely located equipment such as a vending machine 52. The vending machine 52 may have a circuitry 54 which may act as a processor and/or a transceiver. Further, the vending machine 52 may have a local data file 56 and a local conditions indicator 58. These may operate in a manner similar to those of FIG. 3.

The system may also have a communication server 60, a handheld circuitry 62, a business logic database 64, a handheld communications server 66, and a client application 68. The communication server 60, handheld circuitry 62, business logic database 64, handheld communications server 66, and client application 68 may be interconnected by a communications means. This communications means may take the forms described above. For example, the communications means may be an interconnected network using the TCP/IP protocols.

In this example, the communications server 60 may be connected through a communications means to a handheld circuitry 62, such as a PDA. The communications server 60 may also be connected to the business logic database 64 though a communications means.

The PDA 62 may be connected to the handheld server 66 through a communications means. The handheld server 66 may be connected to the business logic database 64 through a communications means. The client application 68 may access the business logic database 64 through a communications means.

The vending machine 52 may communication with the communications server 60 through any communications means. For example, the vending machine 52 may communicate with the communications server 60 through a wireless means.

Further, the vending machine 52 may communicate with a handheld circuitry 66 such as a PDA. The vending machine may communicate with the handheld circuitry 66 using a wireless means or a hardwired connection.

The system 50 may function such that the circuitry 54 may selectively parse and transfer information through various means to the communications server 60 or the PDA 62. The circuitry 54 may also compress and encrypt the information prior to transfer. The PDA 62 may also act to parse, compress, and/or encrypt the information.

For example, the communications server 60 may be connected to the vending machine 52 through a wireless means such as a cellular phone network. The vending machine 52 may send information associated with local conditions 58 such as alarm conditions, door-open conditions and others. Further, the communications server may forward the information to the business logic database 64. The business logic database 64 may act on the information or forward it to a client application 68 where an action may be conducted such as sending a service person.

The service person may access the machine 52 using a PDA or data enabled cellular phone 62. The PDA 62 may be connected to the vending machine using an RS-232 connection. Then, the PDA 62 may access local data files 56 associated with the vending machine 52. The PDA may download information to the vending machine 52. Further, the PDA may send information to the communications server 60 through a wireless means such as a two-way pager network or to a PDA Server 66. The PDA server may be, for example, a cradle for connecting the PDA to a computer. The PDA server 66 may then forward information to the business logic database 64. The information may be transaction history data or diagnostic test results, for example.

The business logic database 64 may then categorize, store and manipulate the information. Further, the client application 68 may access the business logic database 64.

Each of the parts described may be coupled as shown or in any configuration. Many configurations are possible which delivery beneficial functionalities.

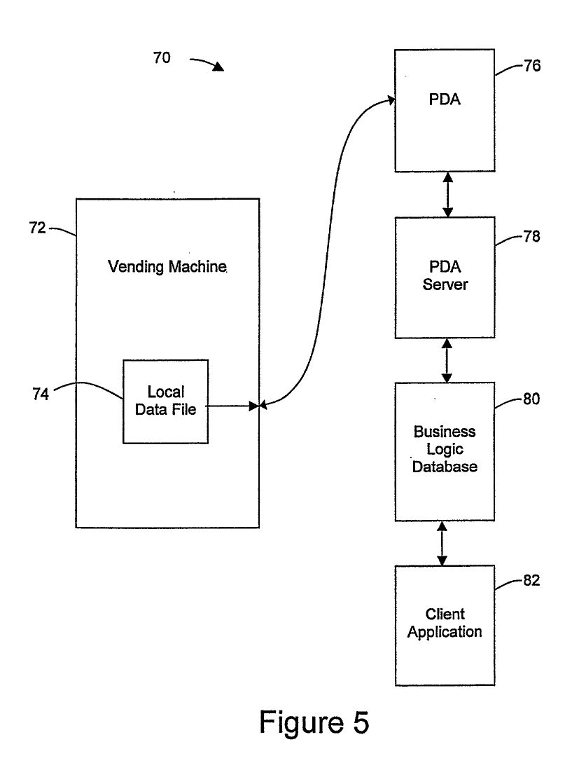

FIG. 5 is a schematic block diagram depicting another exemplary embodiment according to the invention depicted in FIG. 1. The system 70 has a vending machine 72 with a local data file 74. The vending machine 72 may operate in a similar manner to that described in relation to FIG. 3.

In this exemplary embodiment, a handheld circuitry 76 such as a PDA is coupled to the vending machine 72 and may access the local data file 74. In this manner, the PDA 76 may act as the circuitry described in the vending machine of FIGS. 3 and 4. The PDA 76 may connect to the vending machine 72, for example, through an RS-232 connection.

Further, the PDA 76 may retrieve, parse and transmit a data packet associated with a vending event, a transaction history, and/or a local condition, among others. The PDA 76, may transfer the data packet through a communications means to a PDA server 78. The communications means may take many forms including those described above, among others.

In addition, the data packet may be compressed and/or encrypted before transfer. Many compression routines and encryption methods are available, both standard and proprietary.

The PDA server 78 may, through a communications means, transfer the data packet to a business logic database 80. The communications means may take many forms including those described above, among others. Further, the business logic database 80 may take many forms as described above, among others.

Then, a client application 82 may access the business logic database 80 through a communications means as described above. The business logic server and the client application may function similarly to those described in relation to FIGS. 3 and 4.

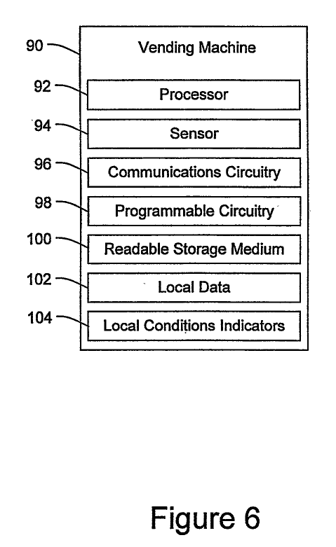

FIG. 6 is a schematic block diagram depicting a vending machine 90 for use in the invention of FIG. 1. The vending machine 90 may include a processor 92, a sensor 94, a communications circuitry 96, a programmable circuitry 98, a readable storage medium 100, a local data file 102, and a local conditions indicator 104, among others. The vending machine may contain some, all, or none of these items. Further, these items may be coupled in many possible configurations.

For example, the sensor 94 may detect a local condition or a vending event. The sensor may be a thermocouple for detecting internal machine temperature, a power sensor, a sensor detecting the sale of an item, an internal clock, or a door-open sensor, to name a few. The local condition may activate the local conditions indicator 104 or be stored in a local data file 102. Similarly, data associated with the vending event may be stored in the local data file 102. The sensor 94 may be coupled to the readable storage medium 100 upon which the local data file 102 may be recorded.

The processor 92 may be coupled to the readable storage medium 100. For example, the processor may be a microprocessor and the readable storage medium may be a memory card. The processor 92 may access the local data file 102 or the local conditions indicator 104. Further, the processor 92 may access the local data file 102 or the local conditions indicator 104 in response to a polling signal received by the communications circuitry 96. The processor 92 may parse data fields from the local data file 102 and/or the local conditions indicator 104 and transfer the data fields with the communications circuitry 96.

The communications circuitry 96 may enable the vending machine to access a communications means. The communications means may be those communications means described in relation to FIG. 1. The communications circuitry 96 may be coupled to the processor 92. The processor 92 may further compress and encrypt the data fields before transferring the data fields through the communications circuitry 96.

A programmable circuitry 98 may be coupled to the processor 92. The programmable circuitry may permit instruction sets to be swapped. These instruction sets may include parsing programs, diagnostic and testing programs, and compression and encryption programs, among others. For example. a parsing program may be included as firmware using the programmable circuitry 98.

A readable storage medium 100 such as a memory card may be coupled to the processor 92. The readable storage medium 100 may for example hold a local data file 102. The local data file 102 may be accessed by the processor. The local data file 102 may be in a standard format such as a DTS or DEX standard format.

Further, a local conditions indicator 104 may be coupled to the processor 92 or the communications circuitry 96. For example, the local conditions indicator may indicate alarm conditions. These alarm conditions may be transmitted through a communications means by the communications circuitry 96. Local conditions indicators 104 may indicate conditions such as temperature, door-open status, power status, and others.

In this manner, transaction data and alarm conditions can be transmitted from remote locations. Further, the data can be parsed, compressed, and encrypted to prepare it for transmission. In this manner, an efficient transfer of information can be accomplished and vending machines 90 can be monitored.

Each of the parts described may be coupled as shown or in any configuration. Many configurations are possible which delivery beneficial functionalities.

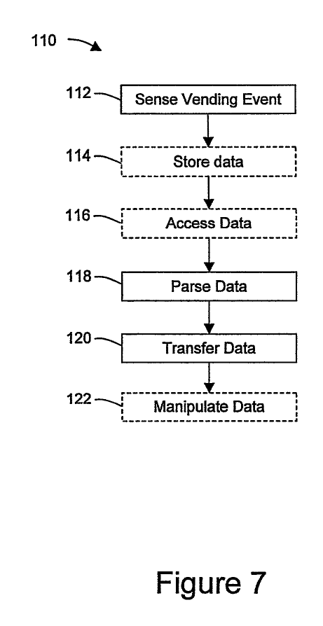

FIG. 7 is a block flow diagram depicting an exemplary method for processing data associated with a vending event for transfer across the interconnected network of FIG. 1. In a block 112, a vending event is detected. As depicted in a block 114, a dataset associated with the vending event may be stored. The dataset may be stored in standard format such as the DEX format. The dataset may be accessed 116. Further, data fields may be parsed from the dataset to form a reduced dataset, as seen in a block 118. The reduced dataset may be transferred from the vending machine. The transfer may occur over a communications means as defined above in relation to the systems of FIGS. 1 through 6. Further, as depicted in a block 122, the reduced dataset may be manipulated and/or stored. The manipulation may be performed, for example, by a business logic database and/or in a client application. The manipulation may result in optimized product selection, improved product placement, enhanced inventory management, optimized scheduling for service, maintenance, and stocking, improved cash accounting and other improvements associated with vending machine management.

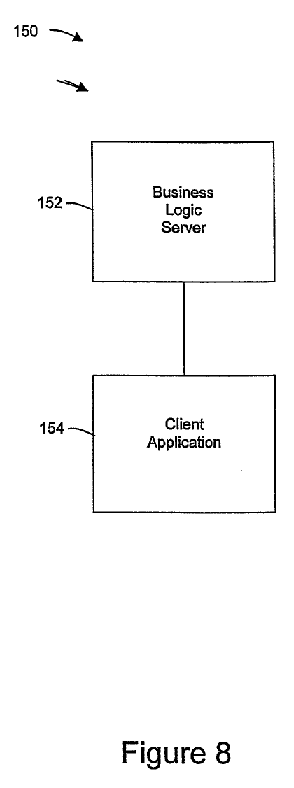

FIG. 8 is a schematic block diagram of a system for inventory management according to the invention depicted in FIG. 1. The system 150 may have a business logic database server 152 and a client application 154.

The business logic database server 152 may hold transaction data and business logic rules. The business logic database server 152 may be a computer running a database such as a Microsoft SQL Server, among others. The business logic database server 152 may function to mine data from the transaction history or optimize routing, scheduling, product selection, and product placement, among others.

A client application 154 may be coupled to the business logic database server 152 through a communications means such as those described above in relation to FIG. 1. The client application 154 may access the transaction history. The client application 152 may also function to mine data from the transaction history or optimize routing, scheduling, product selection, and product placement, among others.

To perform these functions, the client application 154 and the business logic database server 152 may use OLAP tools and other software such as the Cognos data mining tools or Microsoft's Analytical services. The client application 154 and the business logic database server 152 may represent the data in many forms. For example, the data my be represented in a data cube or graphical format.

Each of the parts described may be coupled as shown or in any configuration. Many configurations are possible which delivery beneficial functionalities.

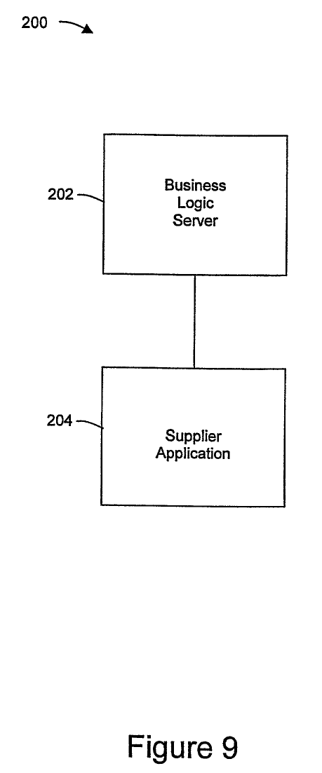

FIG. 9 is a schematic block diagram of a system for supply chain management according to the invention depicted in FIG. 1. The system 200 has a business logic database server 202 and a supplier application 204. The business logic database server 202 may act to determine inventory levels. Inventory replenishing orders may be predicted by the business logic database server. The business logic database server may then place the orders through a supplier application 204.

For example, the business logic database server 202 may connect to the supplier application 204 using a communications means as described. For example, the communications means may be an interconnected network using a TCP/IP protocol. The business logic database server 202 may interface with the supplier application 204 using XML. The supplier application 204 may be a database or ordering system. In this manner, an order may be placed.

Further, the supplier application 204 may access the business logic database server 202. The supplier application 204 may perform data mining functions to determine actions associated with supply chain management. For example, the supplier application 204 may access the business logic database server 202 to find information useful for predicting future orders and customer demand. In this manner a supplier may be able to order raw materials or adjust product lines in response to consumption.

Each of the parts described may be coupled as shown or in any configuration. Many configurations are possible which delivery beneficial functionalities.

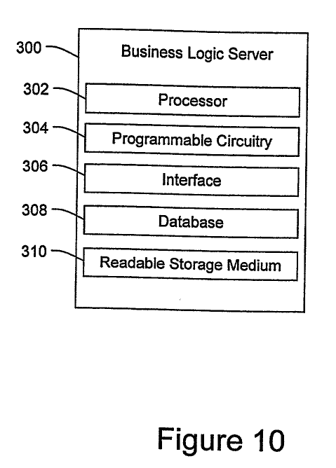

FIG. 10 is a schematic block diagram of a business logic server for use in the system according to the invention depicted in FIG. 1. The business logic database server 300 may have a processor 302, a programmable circuitry 304, an interface 306, a database 308, and a readable storage medium 310. Some, all, or none of these elements may be included. These elements may be configured together, separately, or in any combination.

For example, the business logic database server 300 may be a computer with the Microsoft SQL Server software, among others. The business logic database server 300 may also be a computer running any commercial database.

The processor 302 may be a microprocessor. The programmable circuitry 304 may be coupled to the processor 302. The programmable circuitry 304 may hold instruction sets for use by the processor 302. The programmable circuitry 304 may also enable the system to be adapted through exchange of software.

An interface 306 may be coupled to the processor 302. The interface 306 may take many forms. These forms may include monitor displays, communications circuitry, and others. The communications circuitry may enable communication through an interconnected network. The interconnected network may take many forms such as those described in relation to FIGS. 1 and 2.

The processor 302 may access a database 308. The database may be a Microsoft database or any database. The processor 302 may use the database to store information, business logic rules, and others. The database may be located on a readable storage medium 310. The readable storage medium 310 may hold other programs. These programs may be swapped by the programmable circuitry 304.

The business logic database may be a Microsoft SQL Server running on a compatible computer. The business logic database may also be an Oracle database or any other database programmable to operate with the functions described. Some or all of the functionality described may also be performed by the client application.

Within the business logic database, products and services may be grouped into families. Items within these families may be ascribed common features. These features may include price, commission structure, tax structure, and others. The business logic database may also be functional to permit exceptions for items within a family grouping.

This family structuring may yield improvements in commissions calculations, product selection practices, tax calculations, ordering, system, delivery routing, layering and others. The family structure increases the speed of item entry in the business logic database, transaction presentation by category, and others. As such, the business logic database with the family structures may provide cost and efficiency benefits.

In the business logic database and/or the client application, functionality may be provided to improve scheduling and routing, standalone or in conjunction with the handheld or mobile devices described above. Routes refer to the order and location of machines or vending locations assigned to a delivery truck or person. These routes are often held static. The invention of the present application may provide the ability to dynamically schedule servicing and stocking of machines and direct delivery stores. Further, routes may be altered on an exception basis. For example, a static route may be treated as dynamic during an exception day such as a holiday or in response to illness or vacation of an employee. Exceptions may also occur for unplanned maintenance or unusual product demand.

A graphical user interface may be provided to allow drag and drop route scheduling. Further, optimization routines may suggest improvements to routing. In addition, routines may analysis load balancing on routes. Load balance refers to the workload associated with servicing machines on a specified route. The analysis may be used in determining better routing and scheduling. Furthermore, the routing and scheduling information may be tied to an inventory management function for determining product loading into delivery and service vehicles.

In addition, the client application or the business logic database may perform dynamic route structuring. The dynamic route structuring may optimize stocking and/or servicing of machines and direct store deliveries. The dynamic route structuring may be performed for vending organizations with multiple vending warehouses, multiple vending machine locations, multiple direct store deliveries, and multiple service trucks. This form of dynamic route structuring associates multiple trucks and routes to multiple vending locations in contrast to the traditional one-to-one association.

The business logic database and/or the client application may perform the functions of dynamic scheduling and/or dynamic route structuring using information polled from vending machines, handheld circuitries, and transactional data, among others. The optimization may use data models, data mining, and inventory management predications to determine routes and schedules.

In this manner, dynamic scheduling and dynamic route structuring can reduce costs associated with poor routing, lost time in traffic, lost time caused by attending to functional and stocked machines and others. Further, dynamic scheduling and route structuring can increase sales through improved stocking and machine maintenance.

In one aspect of the invention, the differing commission rate may be easily defined across several aspects, and commissions may be automatically generated. In this manner, the vending machine information may be transmitted to the handheld or other remote device. This may be accomplished either by wireless or wired connection. It may be accomplished with the aid of a human interface at the vending machine, or remotely.

In any case, the information about the particular slottage consumption is relayed electronically from the machine to the end accounting system. An intermediate data transfer step may take place through the hand held unit afforded the delivery route driver. This intermediate transfer step may be relayed to the warehouse, or other stop point, prior to the delivery to the centralized accounting and scheduling system.

Based on the number of deliveries of product from a particular slot in the machine in question, the centralized account system can determine a commission due on the product. In one example, assume that a machine sells three items, cookies, filled cakes, and lollipops. Differing commission rates can be applied to the individual items. In the centralized server, an operator may set the commissions. In this example, the commissions for the cookies are 5 cents per unit, filled cakes are 7 cents, and lollipops are 2 cents.

The electronic data delivered from the vending machine is reported to the centralized server. In this case the data indicates that 12 sales were made in the first slot, 10 sales in the second slot, and 12 sales in the third slot. The server correlates the cookies to the first slot, the filled cakes to the second, and the lollipops to the third. In this manner, the straight-line commission is derived automatically.

Other alternative schemes may devised. A specified percentage of each slot may be defined, or tiered and grouped schemes are envisioned. In a tiered scheme, several commission levels exist, and the varying rates are reached at certain thresholds. In this manner, thresholds per slot may be defined, or thresholds of overall sales may be defined, or thresholds based on multiple products may be defined. Or, tiers based on overall sales in combination with any single slot criteria may be defined.

In another example, many machines can be grouped in the context of commission determinations. In this manner, tiers for sales of a particular item may be defined, as well as tiers of overall sales. Also, tiers of sales for various combinations of single items, as well as being grouped with overall sales may be implemented.

Each tier or grouped scheme may also be implemented with a temporal basis. In this manner the sales of items in a particular sales period may be used, or a floating average may also be implemented in the context of commissions.

Or, commissions may be based on changes of sales. This may be applied to groups of machines, single machines, or to specific products within machines. Or it may applied with various overlays of the foregoing.

Other accounting type functions may be similarly implemented in the system. For example, a sales price of an item has a tax built into the price. The data on sales is taken directly from the machine. In the back end server system, the various taxes based on the jurisdictions the machines are located in may be determined. More than one jurisdictional tax may be imposed on a particular machine. Additionally, some machines may share some jurisdictional taxes, but not others. In this manner, the various jurisdictional tax rates may be defined and applied to the various machines.

Additionally, jurisdictional taxes may exist for some items, but not others. The jurisdictional rates may be defined not just over an entire machine, but also over a particular product or sets of products that appear in that machine.

Thus, the back end server acts to eliminate many problems associated with the determination of commission and taxation determination. Additionally, the data is reported directly to the server without an excess of intermediate steps, in which the data could be garbled or changed.

Additionally the system may be used to control multi-point deliveries with a plurality of delivery vehicles. In most typical contexts, one delivery unit will deliver all products to one or more vending machines. The typical delivery systems do not allow for the use of specialized delivery systems. In this context, the machine may update the centralized server with the status of the vends from the machine over a particular period of time. The centralized server may authorize or determine the delivery to that machine and/or other machines through a particular delivery system.

Or, the system may allow for the use of delivery of specific types of product to the machine in question. For example, the system may determine that the machines in a particular area are very short on chocolate frosted donuts. The system may indicate that one truck with chocolate donuts be dispatched to the various machines. In addition, the system will delete the chocolate donut allotment from the regular delivery that may take place later. This allows the servicer of the vending machines to efficiently allocate the resources to the particular area or products that are needed. In the above mentioned example, the elimination of the chocolate donuts from the regular delivery could allow for that delivery person to service more machines than normal.

Further, the business logic database server 300 may be used to generate predictive features of sales. This predictive analysis may be used to prepay commissions, prepay taxes, or use current download reports from the site with time estimates to delivery to enact delivery of good estimates of product to the site. In this manner, if a machine reports the sale or product level at a particular time, the next delivery will be preplanned at some point in the future with the items needed at the report time and with items that the predictive feature estimates will be used in the time between the report and the next delivery. Of course this may be redone with an interim report.

The business logic database server 300 may enable the delivery items based on static and percentage triggers. This may also be enabled with the dynamic predictive capabilities.

In another aspect, the business logic database server 300 may be used to set grouped unit type delivery schedules based on product bulk group sizes. For example, in a soda delivery, a distributor may not want to break up a twelve pack. Thus when the business logic database server 300 indicates that a particular machine needs twenty six orange drinks, it will simply ask for the replacement of twenty four cans, a multiple of twelve. Of course, this can be used with the predictive aspects discussed earlier.

Additionally, multiple machines may be grouped and enabled with this “group” delivery. In this manner, the bulk items will be aggregated for multiple delivery stops. For example, machine A indicates a need for seventeen cans, and machine B indicates a need for 20 cans. In this manner, three twelve packs will be specified, as the aggregate number for the group is used instead of the aggregate of the machines singly.

With this structure, the business logic database server 300 may function in the invention described in FIGS. 1 through 9. Thus, any aspect of the invention as described previously may be used in conjunction with one another, in an augmenting capacity, or used in these manners with the functionality described in the sections below.

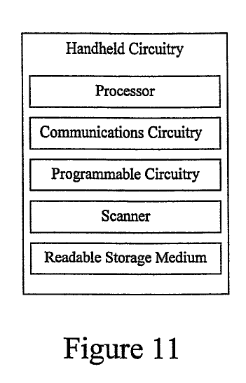

FIG. 11 is a schematic block diagram of a handheld circuitry for use in the invention depicted in FIG. 1. The handheld circuitry may have a processor 402, a communications circuitry 404, a programmable circuitry 406. a scanner 408, and a readable storage medium 410, among others. Some, all, or none of these items may be present. These items may also be coupled and/or connected in many configurations.

For example, a handheld circuitry 400 such as a PDA or a data enabled cellular telephone, may access information in a vending machine. The processor 402 may be coupled to the communications circuitry 404. The communications circuitry 404 may communicate with the vending machine.

The communications circuitry 404 may use a communications means such as those described above. For example, the communications circuitry 404 may be coupled to the vending machine through an RS-232 connection. The communications circuitry 404 may also communication with the vending machine through Bluetooth (TM) circuitry, infrared circuitry, and others. Further, the communications circuitry 404 may communicate with a interconnected network through any other wireless or hardwired communications means.

The vending machine may send information to the handheld circuitry 400. Further, the handheld circuitry 400 may send information to the vending machine through the communications circuitry 404. For example, the vending machine may transfer transaction data to the handheld circuitry 400. In another example, the handheld circuitry 400 may reprogram the vending machine. Further, the communications circuitry 404 may send the information from the vending machine across an interconnected network or retrieve programs for the vending machine from the interconnected network.

The processor 402 may manipulate the information or direct the operation of the handheld circuitry 400. The processor may access a programmable circuitry 406 for instructions. The programmable circuitry 406 may enable instruction sets to be swapped.

Further, the handheld circuitry 400 may have a scanner 408 or other reader. The scanner or other reader may read identifiers optically, magnetically, electronically, or other. The scanner 408 may, for example, read SKUs, money bad bar codes, machine bar codes or other optical, magnetic, or electronic identifying marks. The processor 402 may be coupled to the scanner 408. The processor 402 may direct the transfer, storage, or manipulation of data from the scanner 408. Further, the processor 402 may adjust the behavior or configuration of the handheld circuitry 400 in response to the information acquired through the scanner 408.

The handheld circuitry may also have a readable storage medium 410. The readable storage medium may act to store data, programs, and others. The readable storage medium 410 may swap programs with the programmable circuitry 406 and may be accessed by the processor 402.

A handheld circuitry such as a PDA or a data-enabled cell phone may be used to access information in a vending machine or direct personnel. Thus, functionality may be achieved by a remote connection, or one local to the vending machine. The handheld circuitry may connect to the vending machine through several means. These means may include infrared communication, communication using the Bluetooth (TM) wireless standard, an RS-232 connection using a DEX protocol, combinations of any of the above, and combinations of any the above with wired network communication protocols, among others.

The handheld circuitry may connect to an interconnected network through a communications device. This communications device may include a cellular phone data network (AMPS, GSM, CDPD), a 2-way paging network such as a Reflux (TM) network, a packet radio system (Mobitex(TM), DataTEC (TM)), among others.

The handheld circuitry may function to direct service personnel. The service personnel may be directed to service a specific machine, perform diagnostics on a machine, download data from a machine, and stock a machine in a specified manner, among others. The handheld circuitry may be used to inform the service personnel of the stock items and quantities to be stocked, the location of the machine, the type, model and make of the machine, the repair methods and steps, and others.

The handheld circuitry may download or access a data file such as a DEX data file. The vending machine may parse the data file to a reduced data set. The handheld circuitry may also function to parse the data file. The vending machine may parse the data file on the instruction of the handheld circuitry or the vending machine may follow a prescribed instruction set.

Further, the handheld circuitry may reprogram a processor within the vending machine. The handheld circuitry may add, remove and/or direct the performance of diagnostics. The handheld circuitry may change functionality of the vending machine such as price, identification numbers, parsing routines, encryption routines, communications functionality, and others.

Further, the handheld circuitry may be programmed to detect, program, adapt, and/or communicate with vending machines having various manufactures, designs, firmware, embedded programs, and operating systems, among others. The handheld circuitry can be programmed with specifications, information, drawings, details, and repair instructions associated with various machines. The handheld circuitry may also download programs and files through the communications means discussed above. Thus, specific diagnostics could be applied to the machine, or other operational aspects of the machine could be configured remotely.

In an exemplary embodiment, a Palm(TM) based handheld circuitry may be used to dispatch a service person. The dispatch signal may be delivered through a communications means such as a 2-way pager link. The person may be provided with information associated with the machine such as what items and what quantity of items to stock, what diagnostics to run, and instructions on how to perform these functions. The person may also access a website or other site in an interconnected network to locate information required or to download files.

The person may, for example, connect to the vending machine through an RS-232 connection. Then, the person may then use the handheld to read a parsed, compressed, and encrypted data file from the vending machine. The person may, for example, change the parsing, compressing and/or encrypting routines using the handheld circuitry.

Further, the person may download diagnostics programs from the interconnected network to the vending machine through the handheld circuitry or remotely from a desktop. Then, using the handheld circuitry direct the diagnostics to run and read the results.

If repairs are directed, the person may, for example, download repair instructions and/or updates to embedded software from a remote site through a cellular phone network using the handheld circuitry. The person may then update the embedded software by downloading the software from the handheld circuitry. It should be noted that any and all functionality using the handheld may be accomplished remotely over the network from any node on the network, including a typical computing device. Additionally, while the term handheld is used, it should also include the mobile computing device, such as those found in automobiles. Thus, the term handheld and the functionality described herein may be implemented in a larger computing device that is powered in a vehicle, and whose console is in the cab of the vehicle or otherwise available to the driver or mobile representative.

The business logic database may be structured to permit multiple identifications for individual products through interactions with remote devices, such as the handheld. Promotional items of a product may associate an SKU with a product in the database. The database may have the functionality to permit both the promotional SKU and the non-promotional SKU to identify the same product. Further, the product may be identified with SKUs associated with varying quantities and units of measure. For example, cans of soda may come in pallets, cases, 6-packs and individual cans, among others. These units may each have an associated SKU.

The handheld circuitry such as a PDA, data enabled cellular phone, or combination may be enabled to read and/or recognize the various SKUs. In this manner, the handheld circuitry may function as a bar code scanner. The handheld circuitry may communicate with the business logic database to transfer information associated with the SKUs, the items scanned, and other functions requiring inventory management and SKU reading.

By providing the functionality to associate more than one SKU with an individual product and SKUs with varying unit quantities of an individual product, the business logic database enables a more accurate inventory tracking system. The business logic database may also be used to determine how many units to stock in a machine and when to stock the machine. Through the interconnected network, the business logic database may also use the multiple SKU functionality in directing the actions of service personnel. For example, the business logic database may direct the service personnel and the loading of service vehicles based on unit requirements. For example, vending machines may require 23 drinks and the business logic database would direct the loading of 2 cases of 12.

The SKU/Bar code scanning/reader functionality of the handheld circuitry may also be utilized in cash accounting. For example, machines may be associated with a unique tag or identifier that may be read by the scanner/reader of the handheld circuitry. Cash boxes may also have unique identifier readable by the handheld circuitry. The machine and cash box may be associated together using the handheld circuitry with the reader. As a result, the cash box may be tracked through the counting process. For example, a cash box identifier and machine identifier may be scanned by the handheld circuitry when the cash box is replaced. The handheld circuitry may communicate an association between the cash box and the machine to the business logic database and/or the client application. The cash box identifier may then be scanned at a counting location. The amount collected and counted may then be associated and assigned to the machine by communicating with the business logic database and/or the client application.

As such, improved inventory management can be accomplished through multiple SKU tracking coupled with DEX data and other inventory accounting methods. Similarly, cash accounting can be improved by verifying and comparing accounting through counting, DEX data with denomination accounting and on-location cash metered accounting.

In another embodiment, the business logic database may interface with a database associated with a direct store location. Further inventory management may be accomplished including predictive functions with information from the database associated with the direct store location.

The handheld circuitry may also be used for monitoring and controlling delivery sales. The handheld circuitry may communicate with the business logic database to schedule deliveries of delivery sales. For example, often vending machines are situated in a location where the service personnel stocks vending machines and other supplies such as office supplies, coffee and tea. While serving the vending machine, the service personnel may determine that a delivery of supplies should be scheduled. The service personnel may schedule a delivery using the handheld circuitry. The handheld circuitry may then communicate the scheduled delivery to the business logic database. The business logic database or the client application may then schedule a delivery. Further, the service personnel may take inventory. The business logic database may predict when a supply delivery should be schedules based on the inventory.

Further, information collected through the interconnected network may be used in the inventory system associated with the business logic database to predict ordering from suppliers. Information collect, for example, through parsed datasets from vending machines can be used to predict inventory requirements. Further, the business logic database may suggest, generate, and/or effect an order from a supplier. The business logic database may also direct the order to be sent to a selected warehouse as needed. The client application may also function to predict, suggest, generate and/or effect an order and direct the order be sent to a selected warehouse.

In this function, a business logic database such as a Microsoft SQL Server may mine the information received from vending machines, stores, and delivery routes to determine an expected inventory quantity for replenishing supply at a warehouse. The business logic database may then generate the order. Further, through an interface such as an XML interface, the business logic database may place the order with a supplier and direct the delivery of the order to the appropriate warehouse.

In this manner, inventories can be optimized. Costs may be reduced through smaller inventories. Product quality may be improved through higher turnover associated with smaller inventories and as-needed or just-in-time ordering.

Once the product is in the warehouse, the business logic database may also function to direct the delivery. For vending machines, direct store deliveries, and service deliveries, the business logic database may function to optimize service and stocking functions. An improved inventory management system may enable optimization of service routing, improved loading of service vehicles, and improved sales.

The improved inventory management system may yield cost reductions by reducing calls. Further, the improved inventory management system may increase sales by limiting lost sales caused by low inventory at the transaction location, lost sales caused by erred operation of remote equipment, and others.

Further, consumer demand information acquired through the interconnected network may be used by suppliers. The business logic database may predict consumer demand. The business logic database may also be accessed by supplier applications to determine demand. By determining consumer demand and tastes, the supplier may optimize production schedules and purchase of raw materials. Further, the supplier may adjust product lines to meet changing demand.

In a similar manner, clients and owners of vending machines and direct store delivery contracts may access the business logic database to ascertain consumer demand and tastes. Increased sales may be acquired by adapting to changing consumer tastes and demand. Adapting may involve changing product lines, placement, and others.

Further, consumer demand and tastes can be evaluated using data filtered by location and demographics. For example, vending sales and direct store delivery sales may be characterized by neighborhood. Similarly, vending machines may be characterized by location such as a hospital versus a middle school. By associating location and neighborhood characteristics venders may be able to optimize product placement and selection.

In addition, products may be test marketed using an adaptable system. Machines connected to the interconnected network and operable for adjustments may be used to test the effects of product type, product display and product price, to name a few. For example, the price of a product may be altered and the sales monitored to test price points. Using an automated vending machine system connected to an interconnected network would permit easy monitoring and testing of market hypotheses. Similarly, monitoring and testing in direct store delivery locations could permit testing of market hypothesis. The handheld circuitry, business logic database and client application may all function to aid in inventory accounting and data analysis.

Thus, an architecture for dynamically operable vending machine interface and predictive engine is described. It should be noted that such an architecture may be implemented with a computing device. The computing device may be a general purpose or specialized computing device. It should also be noted that the architecture may be implemented as software run on the computing device and within such components as magnetic media or computer memory associated with the computing device.

In view of the above detailed description of the present invention and associated drawings, other modifications and variations will now become apparent to those skilled in the art. It should also be apparent that such other modifications and variations may be effected without departing from the spirit and scope of the present invention as set forth in the claims which follow.

What is claimed is:

1. A method for collecting information associated with a vending machine, the method comprising:
detecting a vending event associated with the vending machine;
storing a dataset associated with the vending event, the dataset being stored in a standard format;
retrieving the dataset;
parsing at least one data field from the dataset; and
transmitting the at least one data field.

2. The method of claim 1 wherein the standard format is the DEX format.

3. The method of claim 1 wherein the at least one data field is transmitted to a handheld circuitry.

4. The method of claim 1 wherein the at least one data field is transmitted by a wireless means.

5. The method of claim 1 wherein the at least one data field is transmitted at least in part over an interconnected network.

6. The method of claim 1 wherein the at least one data field is transmitted to a central monitoring facility.

7. The method of claim 1 wherein the at least one data field is transmitted by a communications means, the communications means selected from a group consisting of a telephone line, an Ethernet, a wireless Ethernet, a two-way paging system, a mobile phone system, a cellular phone system, a packet-radio system, a fiber optic network and the Bluetooth (TM) wireless communication standard.

8. The method of claim 1 wherein the at least one data field is transmitted in a data packet, the data packet comprising the data field and a unique identification number associated with the vending machine.

9. The method of claim 1 wherein the at least one data field is transmitted is response to a polling signal.
